(19) United States
(12) Patent Application Publication
(10) Pub. No.: US 2025/0095331 A1
(43) Pub. Date: Mar. 20, 2025

(54) SYSTEM AND METHOD FOR DETERMINING A MATERIAL OF AN OBJECT

(71) Applicant: TRINAMIX GMBH, Ludwigshafen (DE)

(72) Inventors: Nicolas WIPFLER, Ludwigshafen (DE); Peter SCHILLEN, Ludwigshafen (DE); Benjamin GUTHIER, Mannheim (DE)

(21) Appl. No.: 18/729,250

(22) PCT Filed: Feb. 15, 2023
(86) PCT No.: PCT/EP2023/053775

§ 371 Date: Jul. 16, 2024

(30) Foreign Application Priority Data
Feb. 15, 2022 (EP) 22156855.3

(51) Int. Cl. G06V 10/74; G06V 10/25; G06V 10/82; G06V 40/16; G06V 40/40

(52) U.S. Cl. CPC G06V 10/74; G06V 10/25; G06V 10/82; G06V 40/45; G06V 40/172

(57) ABSTRACT

Disclosed herein is a system for determining a material of an object. The system includes an image providing unit, a material score determination unit, a material determination unit and an output unit. The image providing unit is configured for providing at least two images, each showing a part of the object. The material score determination unit is configured for determining a material score for each of the at least two images, the material score being indicative of a presence of a predefined material in the respective image. The evaluation unit is configured for evaluating the material scores determined for each of the at least two images. This material determination unit is configured for determining the material of the object based on the evaluation. The output unit is configured for outputting the determined material of the object.

### FIELD OF THE INVENTION

The invention relates to a system and to a method for determining a material of an object. Moreover, the invention relates to a computer program for determining a material of an object and to a non-transitory computer readable data medium storing the computer program. The invention particularly relates to determining a material of an object as part of an authentication process implemented for preventing unauthorized access to an electronic device. However, the invention may also be used in other fields of technology such as security technology, production technology, safety technology, documentation or technical purposes, maintenance, agriculture, cosmetics, medical technology or in the sciences.

### BACKGROUND OF THE INVENTION

In various situations, it may be required to determine a material of an object. For example, in certain situations it may be required to distinguish biological material such as human skin from non-biological material as described inter alia in US 2016/155006 A1.

In WO 2020/187719 A1, a detector is disclosed for identifying at least one material property. The detector comprises at least one sensor element and at least one evaluation device. The detector may be configured for determining and/or validating whether a surface to be examined or under test is or comprises biological tissue, in particular human skin, and/or to distinguish biological tissue, in particular human skin, from other tissues, in particular other surfaces, and/or distinguishing different types of biological tissue such as distinguishing different types of human tissue e.g. muscle, fat, organs, or the like.

However, a situation may occur in which a material of an object shall be determined, but a part of the object is covered with a different material. For example, a face may be partly covered by glasses. In such a situation, it may happen that actually the material of the part covering the object of interest is determined and falsely assigned to the object itself. Considering an authentication process comprising facial recognition this may lead to a refusal of access to an electronic device, only, because the material of the part covering the object and not the material of the object itself has been determined. Another scenario may be that in an authentication process access is denied since the material of the object cannot be determined with sufficient certainty.

It would thus be advantageous if it were possible to determine a material of an object more reliably even if some parts of the object are covered with a different material.

### SUMMARY OF THE INVENTION

The present invention is based on the objective of providing an improved or at least alternative system, method, and computer program for determining a material of an object. Preferably, with the system, the method, and the computer program it shall be possible to determine a material of an object more reliably, in particular, even if some parts of the object are covered with another material. Thus, the system, the method, and the computer program shall be comparatively robust against disturbances, in particular, if the disturbance is limited to a small part of an image of the object. It is further preferred that the system, the method, and the computer program require comparatively less data thereby providing a comparatively large degree of accuracy in determining a material of an object.

According to the invention, a system for determining a material of an object is proposed. The system comprises an image providing unit, a material score determination unit, an evaluation unit, a material determination unit, and an output unit.

The image providing unit is configured for providing at least two images each showing a part of the object. The material score determination unit is configured for determining a material score for each of the at least two images. The material score is indicative of a presence of a predefined material in the respective image. The evaluation unit is configured for evaluating the material scores determined for each of the at least two images. The material determination unit is configured for determining the material of the object based on the evaluation. The output unit is configured for outputting the determined material of the object.

The invention includes the recognition that when determining a material of an object based on an image showing the object a situation may occur in which parts of the object are covered by a different material. The prior given example would be a face covered by glasses. In such a situation, it may happen that the material covering the object is falsely determined as the material of the object itself.

With the system according to the invention, the risk of assigning a false material to an object may be reduced. The system may thus determine the material of an object comparatively reliable. The system has the particular advantage that a material of an object can be determined in a comparatively robust manner even if disturbances are present in an image. In particular, the impact of small disturbances present in some parts of the object, e.g., a presence of a material covering the object, may be reduced when determining the material of an object. A further advantage of the system is that it requires a comparatively smaller amount of data, e.g., a smaller number of images, for determining the material of an object. For example, a single region-of-interest image may be sufficient when it is divided into a number of partial images that are used by the system for determining the material of an object. A determination of the material of an object can thus be achieved with the system comparatively fast and with reduced effort. At the same time, the material of an object can be determined with comparatively high accuracy with the system.

This is achieved by the system in that for at least two images, each showing a part of the object, an individual material score is determined. Each of the material scores may be independent of the other material scores and is indicative of a presence of a predefined material in that respective image. Accordingly, with a system it is possible to provide several material scores associated with different parts of the object. It is a particular advantage, that each of the material scores is associated with a specific part of the object such that an error resulting from an averaging over the complete object may be reduced. Considering again the example of a face partly covered by glasses, it may thus be possible to determine with the system a material score for a part in which glasses cover the face and one or more further material scores associated with other parts of the face that are uncovered.

With the evaluation unit, the several material scores can be evaluated to obtain an evaluation result. In particular, each of the material scores may contribute individually to obtain the evaluation result. In other words, for generating an evaluation result, different parts of the object and the corresponding material scores may be considered. For example, the evaluation result may represent some degree of likelihood that the object comprises a certain material. With the material determination unit, the material of the object can be determined taking into account the result of the evaluation. For example, the evaluation result may be compared to a reference or a threshold value for determining the material of the object. With the system, it may thus be possible to determine a material of an object more reliably. In particular, with the system it may be possible to reduce the risk that a material covering some parts of the object may contribute to a large extend to the process of determining the material of the object. It may thus be avoided to assign an incorrect material to the object.

It is particularly preferred that the material of the object as determined with the system is further used in an authentication process. For example, if a face of a person needs to be recognized, the determination of its material to be human skin may be used as part of the authentication process, e.g., combined with facial recognition, to avoid spoofing, for example by providing a silicone mask to a camera imitating the face of an authorised user.

The system may determine the material of the object with increased reliability, in particular, if the at least two images show different parts of the object. Of course, it may be possible, that the at least two images show different parts of the object that partly overlap.

With the system, different kinds of materials can be determined. This may be achieved by taking into account the interaction between light and the object, e.g., for determining a material score associated with a certain part of the object. For example, if light impinges onto certain materials like human skin, the impinging light is expected to penetrate into the object and is reflected from inside the object. Considering other materials like metals, impinging light is expected to be almost fully reflected at the outer surface of the object. Furthermore, a light spectrum of the reflected light as captured by the camera may be considered for determining a material score associated with a certain part of the object. Thereby, it can be taken into account that certain materials reflect light within a specific spectral range. Alternatively or additionally, properties of a specular reflection and/or of a diffuse reflection such as an intensity distribution or a peak broadening may be taken into account, e.g., for determining a material score associated with a certain part of the object. The latter properties may be particularly relevant if the object is illuminated with patterned light, i.e., with a number of light spots that are captured by a camera.

The material to be determined by the system may be a biological material comprising living cells. In particular, biological material may be or may comprise human tissue or parts thereof such as skin, hair, muscle, fat, organs, or the like. Biological material may also be or may comprise animal tissue or a part thereof such as skin, fur, muscle, fat, organs, or the like. Biological material may also be or may comprise plant tissue such as wood or a part thereof. Biological material may also comprise cotton or silk or the like used for, e.g., making textiles such as cloth or carpets.

A material to be determined may also be an inorganic material such as, metal, or plastics like polyethylene terephthalate (PET) or polyvinyl chloride (PVC), or synthetic textiles, e.g., used for making cloth or carpets.

The system may be adapted to distinguish biological material, e.g., human tissue, animal tissue or plant tissue or parts thereof from one or more of inorganic tissue, metal surfaces, or plastics surfaces. The system may be adapted to distinguish food and/or beverage from dish and/or glasses. The system may be adapted to distinguish different types of food such as a fruit, meat, and fish. The system may be adapted to distinguish a cosmetics product and/or, an applied cosmetics product from human skin. The system may be adapted to distinguish human skin from foam, paper, wood, a display, a screen. The system may be adapted to distinguish human skin from cloth. The system may be adapted to distinguish a maintenance product from material of machine components such metal components etc. The system may be adapted to distinguish organic material from inorganic material. The system may be adapted to distinguish human biological tissue from surfaces of artificial or non-living objects.

The system may be a stationary device or a mobile device. Examples of mobile devices include mobile telephones or smart phones, tablet computers, laptop computers, portable gaming devices, portable Internet devices, and other handheld devices, as well as wearable devices such as smart watches, smart glasses, headphones, pendants, earpieces, etc.

Further, the system may be a stand-alone device or may form part of another device, such as a computer, a vehicle or any other device. Further, the system may be a hand-held device. Other embodiments of the system are feasible.

The system and in particular the evaluation unit may comprise at least one database comprising a list and/or table comprising a number of predefined materials and associated material names and/or material groups.

Preferably, the at least two images are partial images each showing a part of a region of interest contained in a region-of-interest-image. In other words, preferably, the at least two images are partial images generated from a region-of-interest-image. In this case, the partial images each show are part of the region-of-interest-image. Preferably, the region-of-interest-image is flood light image or a pattern image or is generated from a flood light image or a pattern image. For obtaining a partial image, a partial image can be extracted or generated from the region-of-interest image, e.g., by image processing. Accordingly, a partial image is an image obtained from a region-of-interest image and showing a part or fraction of the region-of-interest image.

Preferably, the region-of-interest image is a single-shot image. Preferably, the region-of-interest-image is an image substantially showing a selected or predefined region of interest of the object, for example, a face or a piece of a carpet lying on a floor. The region-of-interest-image may be generated by capturing with a camera the object in a way that only the region of interest is recorded. Alternatively, the region-of-interest-image may be generated by cropping an original image such that the region-of-interest-image substantially shows the selected region of interest. It is thus possible that the region-of-interest image is divided into several partial images. For example, the region-of-interest image may be divided into several partial images such that when combining the partial images, the region-of-interest image can be reconstructed.

For generating the at least two images provided by the image providing unit, the region-of-interest-image may be divided into at least two partial images representing the at least two images provided by the image providing unit. Preferably, each of the at least two images shows a part of the region of interest shown in the region-of-interest-image.

Of course, a region-of-interest-image can be divided into a larger number of partial images, e.g. between 10 and 250 partial images, such as 16, 32, 64 or 128 partial images. Depending on the application even a larger number of partial images, e.g., 500 or more or 1000 or more may be beneficial.

The region-of-interest-image may be a RGB image of the object. Alternatively, the region-of-interest-image may show the object being illuminated by a point cloud. In particular, the region-of-interest-image may be an infrared (IR) image.

Accordingly, the at least two images may be RGB images of a part of the object. Alternatively, the at least two images may show parts of the object being illuminated by a point cloud. In particular, the at least two images may be IR images.

Preferably, the material score determination unit is configured for determining for each of the partial images representing the at least two images provided by the image providing unit an individual material score. Each of the material scores, preferably, represents a likelihood that the associated part of the object shown in the respective image is made of the predefined material, e.g., a material of interest.

In general, the material score may be expressed by a single value between 0 and 1, in particular, if only one material is to be determined. For example, it may be determined if an object comprises human skin or not. Preferably, a material score of 0 may indicate a likelihood of 0% that the object comprises the predefined material. Accordingly, a material score of 1 may indicate a likelihood of 100% that the object comprises the predefined material.

The material score associated with an image of the at least two images may also be expressed by a vector or by a matrix. Each vector element or each matrix element may be a value between 0 and 1. Such a representation of a material score as a vector or a matrix may be feasible if several materials are to be determined for one image. One example of a situation in which several materials are to be determined may be based on an image showing a carpet lying on a floor. For example, it may be determined whether the floor is made of PET, PVC or wood and whether the carpet is made of an organic or synthetic textile. After having determined a material score for each of the materials to be determined, the resulting material scores can be provided as vector or a matrix of material scores.

In particular, based on a likelihood that a certain predefined material is present in a respective one of the at least two images, the material score determination unit is configured for determining a material score for each of the at least two images.

Preferably, for determining a material score, the material score determination unit comprises a material score determination model that is configured for receiving the at least two images each showing a part of the object as input and for determining a material score for each of the at least two images. The material score determination model may be a classification model such as a data-driven model or may be a mechanistic model. The material score determination model may be parametrized and/or trained based on a training data set comprising a plurality of images and associated therewith corresponding material scores. Preferably, the material score determination model is parametrized and/or trained for outputting a material score for each of the at least two images.

Accordingly, it is particularly preferred that the material score determination unit comprises a data-driven model configured for determining the material score for each of the at least two images. Additionally or alternatively to a data-driven model, the material score determination unit may comprise a mechanistic model configured for determining the material score for each of the at least two images. Preferably, the data-driven model is a neural network trained for determining the material score for each of the at least two images using the at least two images as input.

The trained neural network can be a multi-scale neural network or a recurrent neural network (RNN) such as, but not limited to, a gated recurrent unit (GRU) recurrent neural network or a long short-term memory (LSTM) recurrent neural network. Alternatively, the neural network may be a convolutional neural network (CNN).

The neural network may be trained using training data, e.g., comprising images showing a part of an object and associated material scores. For example, if the neural network is a feedforward neural network such as a CNN, a backpropagation-algorithm may be applied for training the neural network. In case of a RNN, a gradient descent algorithm or a back-propagation-through-time algorithm may be employed for training purposes. As a result of the training, operating parameters for the neural network circuitry are generated such that when receiving at least two images showing a part of an object as input, the trained neural network outputs an associated material score as a prediction. As stated before, for determining the material score for an image showing a part of the object, the way of light interacting with that part of the object can be taken into account.

The neural network may also be trained to identify a material present in a certain part of the object represented by a respective one of the at least two images. For example, the neural network may be trained for classifying a material to be determined. Classes of materials may be, e.g., human skin, PVC, PET, silicone, metal, wood, etc. The trained neural network may output a material score indicating a likelihood that a material belonging to a certain predefined class is present in the respective image.

Preferably, the evaluation unit may be further configured for evaluating the determined material scores by setting the determined material scores in relation to a reference quantity such as a predefined threshold value or a reference, e.g., a reference material score. The threshold may be a likelihood value and the determined material scores may be compared to that threshold for obtaining an evaluation result. Additionally or alternatively, the evaluation unit may be further configured for evaluating the material scores by setting the determined material scores in relation to a reference material score. A reference material score may be associated with a reference image showing a known material. For example, the determined material scores may be compared to a reference material score for obtaining an evaluation result. Additionally or alternatively, it is possible that evaluating the material scores incudes classifying the determined material scores. For example, evaluating the material scores may be carried out using a data driven model such as a classification model like a neural network or a vision transformer. For example, a classification model may be configured for evaluating the material scores by providing a prediction that the object comprises or does not comprise the predefined material.

Preferably, the evaluation unit is further configured for evaluating the material scores determined for each of the at least two images by forming an average material score of the determined material scores. This has the advantage that the material of the object is not determined based on single outliers. Instead, the material of the object is determined based on the most predominant material scores. For forming the average material score, the evaluation unit may be configured to neglect outliers in a predefined manner.

Preferably, the material determination unit is further configured for comparing the average material score to a predefined threshold value. If the average material score is above the predefined threshold value, the object may be identified, e.g., by the material determination unit, as being of the predefined material. If the average material score is below the predefined threshold value, the object may be identified, e.g., by the material determination unit, as not being of the predefined material.

Preferably, the predefined threshold value is set such that a false positive rate and a false negative rate on a test data set is about the same. This has the advantage that the material of an object can be determined with an increased reliability. In particular, thereby it can be avoided that too many false negative results are produced may setting the threshold value to high. Likewise, it can be avoided too many false positive results are produced by setting the threshold value too low. By setting the predefined threshold value such that a false positive rate and a false negative rate on a test data set is about the same, it can be taken into account that the training, evaluation and test data sets are often not complete to prepare the system for every conceivable situation it may have to handle.

In particular, when forming an average material score, the evaluation unit may be further configured for evaluating the material scores determined for each of the at least two images by giving a weight to each of the at least two images. For example, a material score of a respective image may be multiplied with the weight for obtaining a weighted material score. The weight preferably indicates how important the respective image is for the determination of the material. Taking the example of facial recognition, typically the area of the face that is close to the hair is generally less important because it can be assumed that this area often is hidden behind the hair. However, the area around the nose and the mouth can be considered of increased importance. Accordingly, sticking with the example of a face, an image showing parts of the mouth or nose may be assigned with a higher weight compared to an image showing parts close to the hair.

Preferably, the material determination unit is further configured for determining the material of the object based on the comparison of the average material score with the predefined threshold value. In particular, the material determination unit may determine that the object comprises the predefined material if the average material score exceeds the threshold value. Correspondingly, the material determination unit may determine that the object does not comprise the predefined material if the average material score is smaller than the threshold value.

Preferably, the evaluation unit may be further configured for evaluating the material scores by forming an average material score of the determined material scores based on the weights assigned to each of the at least two images. The weight average material score may be calculated by multiplying each element of a material score vector with the corresponding weight value associated with the respective part of the object. For example, a segmented image may be provided which indicates segments of the object with an associated weight value indicating an importance of a specific segment for the determination of the material. Thereby, parts of the object that are expected to be of increased importance for the determination of the material of the object may contribute stronger to the formed weight average material score.

Preferably, the material determination unit may be further configured for comparing the weight average material score that was based on the weighted material scores to the predefined threshold value.

Additionally or alternatively, the evaluation unit is further configured for comparing the material scores determined for the at least two images to a reference. The reference, preferably, comprises at least one reference material score determined from a reference image showing a known reference material. For example, the reference can be a reference material score vector comprising reference material scores as vector elements. For example, the material scores may be expressed by a material score vector or matrix. In particular, the reference may be a stored material score vector or matrix from an image in which the material of a part of an object is known. For example, the known material can be the material of interest that is to be determined for the object. As an example, the reference may be associated with the known material “human skin” such that by comparing the material score of the at least two images with the reference it may be determined whether the part of the object shown in the images indeed shows human skin. Taking the example of facial recognition, the reference may be available from the enrolment process in which a user scans her or his face thus generating a reference image in order to set up the recognition system.

For example, the evaluation unit may be configured for evaluating the material scores by comparing each of the material scores determined for the at least two images in an element-wise manner to the reference.

Additionally or alternatively to the element-wise comparison, for evaluating the material scores, the evaluation unit may comprises a neural network that is trained for receiving the material scores of the at least two images and the reference as input and for outputting based on the input a prediction of the material of the object. The neural network may also be trained to output binary information whether the part of the object of a particular image shows the material of the reference or not. Alternatively, the neural network may be trained to output a likelihood indicating whether the part of the object of a particular image shows the material of the reference or not. The likelihood may be translated into a decision, e.g., by setting a threshold depending on the use case by the material determination unit.

The trained neural network of the evaluation unit may be a multi-scale neural network or a RNN such as, but not limited to, a GRU recurrent neural network or a LSTM recurrent neural network. Alternatively, the neural network may be a CNN. The neural network may be trained using training data, e.g., comprising material scores together with a reference and associated known materials.

The material determination unit may be configured for determining the material of the object based on the element-wise comparison of the material scores of the at least two images with the reference. Alternatively or additionally, the material determination unit may be configured for determining the material of the object by comparing the prediction of the material of the object provided by the trained neural network to a predefined use case threshold value.

It may be advantageous, if the image providing unit is configured for providing each of the at least two images together with a position information indicative of a relative position on the object. The evaluation unit may comprise a neural network that is trained for receiving the material score of a respective image together with the position information of this image as input and for outputting based on the input a prediction of the material of the object. Position information of an image can be provided as 3D information representing a position in space, e.g., in the coordinate system of the object.

Preferably, the neural network is trained to know at which position on the object the material score is more relevant for the determination of the material than other positions. Preferably, the neural network is trained to output the binary decision or a likelihood whether the material of the object matches the predefined material.

It is particularly preferred that the trained neural network is a point net neural network. Alternatively, the trained neural network of the evaluation unit may be a multi-scale neural network or a RNN such as, but not limited to, a GRU recurrent neural network or a LSTM recurrent neural network. Alternatively, the neural network may be a CNN. The neural network may be trained using training data, e.g., comprising material score of a respective image together with the position information of this image and associated known materials.

The system may further comprise an authentication unit configured for authenticating the object using the determined material of the object. The authentication unit may be configured to combine the information of the determined material of the object with other authentication processes such as facial recognition to increase the security level of validating the authorisation of a requestor.

The invention also relates to a method for determining a material of an object, said method comprising the steps of
providing at least two images each showing a part of the object,
determining a material score for each of the at least two images, said material score being indicative of a presence of a predefined material in the respective image,
evaluating the material scores determined for each of the at least two images,
determining the material of the object based on the evaluation, and
outputting the determined material of the object.

The method may be carried out using the system for determining a material of an object as described before.

The invention also relates to a computer program for determining a material of an object, the computer program including instructions for executing the steps of the method as defined before, when run on a computer. The invention also relates to a non-transitory computer readable data medium storing the computer program.

The non-transitory computer readable data medium storing the computer program may be part of the system for determining a material of an object as described before.

The invention also relates to an authentication process, e.g., a biometric authentication process, said authentication process comprising the steps of
performing biometric recognition of a user, e.g., on a face presented to a camera, or by determining a fingerprint with a fingerprint sensor, preferably, by conducting the sub-steps of
   providing a detector signal from a camera, said detector signal representing an image of the user's feature, e.g., a fingerprint or a face;
   generating a low-level representation of the image;
   validating an authorisation of the user based on the low-level representation of the image and a stored low-level representation template, and
if the biometric recognition is successful, determining the material of the face, preferably, by conducting the sub-steps of
   determining the material of the face shown in the image;
   comparing the determined material to a stored predefined material,
providing a positive authentication output signal if the determined material matches the stored predefined material. Otherwise, in case of no matching between the determined material and the predefined material, a negative authentication output signal may be provided. In other words, generally, an authentication output signal may be provided indicative of whether the determined material matches the stored predefined material.

The material may be determined based on one or more material scores determined for at least two images of the object and in particular by executing the method for determining a material of an object as described before.

In case the validation step already yields a negative result, a negative authentication output signal may be provided without determining the material.

In an alternative biometric authentication process, initially the material of the object, e.g., of the face presented to a camera, is determined and afterwards, in case of a successful match of the determined material to a predefined material, the facial recognition process is carried out.

It shall be understood that the aspects described above, and specifically the system of claim 1, the method of claim 13 and the computer program of claim 14, have similar and/or identical preferred embodiments, in particular as defined in the dependent claims.

It shall be understood that a preferred embodiment of the present invention can also be any combination of the dependent claims or above embodiments with the respective independent claim.

These and other aspects of the present invention will be apparent from and elucidated with reference to the embodiments described hereinafter.

### BRIEF DESCRIPTION OF THE DRAWINGS

FIG. 1 schematically and exemplarily shows an image recording device;

FIG. 2 schematically and exemplarily shows an image processing device utilizable for generating at least two images of an object;

FIG. 3 schematically and exemplarily shows a system for determining a material of an object;

FIG. 4 shows a flowchart representing a method for determining a material of an object;

FIG. 5 shows a flowchart representing steps performed for evaluating material scores by forming an average material score;

FIG. 6 shows a flowchart representing steps performed for evaluating material scores including a comparison of the material scores to a reference;

FIG. 7 shows a flowchart representing steps performed for evaluating material scores by forming a weight average material score;

FIG. 8 shows a flowchart representing steps performed for evaluating material scores based on position information provided for each of the material scores; and

FIG. 9 shows a flowchart representing an authentication process comprising determining a material of a user to be authenticated.

### DETAILED DESCRIPTION OF EMBODIMENTS

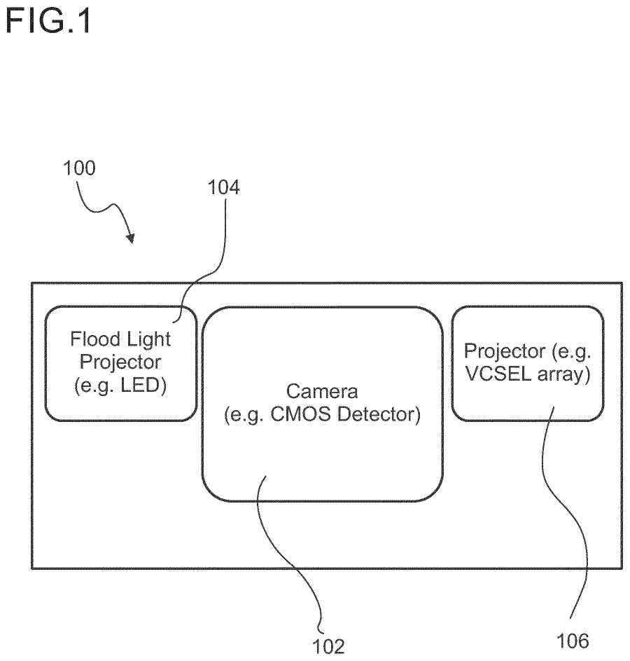

FIG. 1 schematically and exemplarily shows an image recording device 100. The image recording device 100 may be, e.g., a cell phone. The image recording device 100 comprises a camera 102 and two projectors, a first projector 104 for illuminating flood light, e.g. an LED, and a second projector 106 for illuminating a light pattern, e.g. a VCSEL (vertical-cavity surface-emitting lasers) array. Accordingly, with image recording device 100 it may be possible to capture an RGB image of a scene and/or an image from a scene, which is illuminated by a point cloud, i.e., a pattern image.

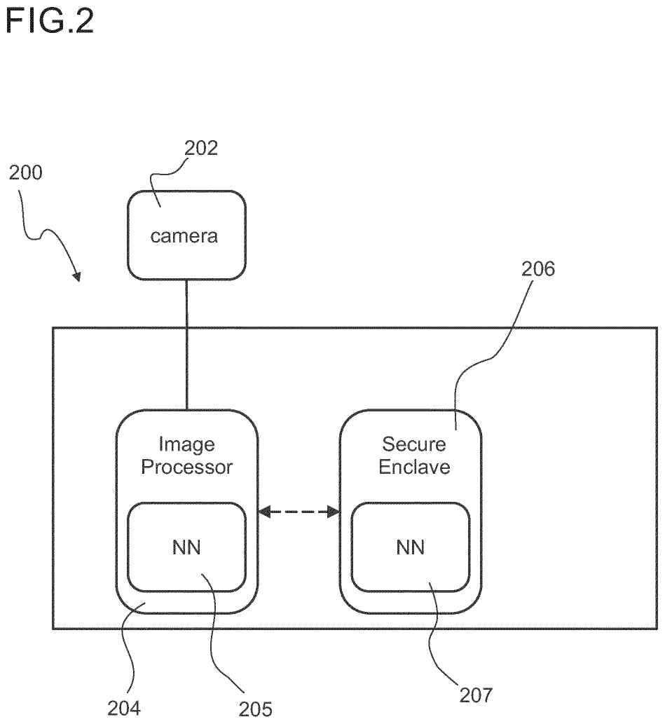

The camera 102 of the image recording device 100 can capture at one point in time an object illuminated by flood light with the first projector 104 and at another point in time illuminated by light patterns produced by the second projector 106. These images, i.e. the pattern image and the flood light image, may then be transmitted to an image processor, e.g., as described with reference to FIG. 2.

The camera 102 may include one or more image sensors for capturing digital images. An image sensor may be an array of sensors. Sensors in the sensor array may include, but are not be limited to, charge coupled device (CCD) and/or complementary metal oxide semiconductor (CMOS) sensor elements to capture IR images or other non-visible electro-magnetic radiation. The camera 102 may include more than one image sensor to capture multiple types of images. For example, the camera 102 may include both IR sensors and RGB (red, green, and blue) sensors. In certain embodiments, an image sensor of camera 102 is an IR image sensor and the image sensor is used to capture infrared images used for face detection, facial recognition authentication, material detection and/or depth detection.

First and second projectors 104, 106 preferably comprise at least one light source, e.g., a plurality of light sources. First and second projectors 104, 106 may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the first and second projectors 104, 106 may have a wavelength of 300 to 1100 nm, especially 500 to 1100 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1100 nm may be used. Using light in the near infrared region allows that light is not or only weakly detected by human eyes and is still detectable by silicon sensors, in particular standard silicon sensors.

First and second projectors 104, 106 may be adapted to emit light at a single wavelength. In other embodiments, the first and second projectors 104, 106 may be adapted to emit light with a plurality of wavelengths allowing additional measurements in other wavelengths channels. The first and second projectors 104, 106 may be or may comprise at least one multiple beam light source. For example, the first and second projectors 104, 106 may comprise at least one laser source and one or more diffractive optical elements (DOEs).

Specifically, the first and second projectors 104, 106 may comprise at least one laser and/or laser source. Various types of lasers may be employed, such as semiconductor lasers, double heterostructure lasers, external cavity lasers, separate confinement heterostructure lasers, quantum cascade lasers, distributed bragg reflector lasers, polariton lasers, hybrid silicon lasers, extended cavity diode lasers, quantum dot lasers, volume Bragg grating lasers, Indium Arsenide lasers, transistor lasers, diode pumped lasers, distributed feedback lasers, quantum well lasers, interband cascade lasers, Gallium Arsenide lasers, semiconductor ring laser, extended cavity diode lasers, or vertical cavity surface-emitting lasers. Additionally or alternatively, non-laser light sources may be used, such as LEDs and/or light bulbs. The first and second projectors 104, 106 may comprise one or more diffractive optical elements (DOEs) adapted to generate the illumination pattern.

In particular, for face detection, projector 104 may provide flood IR illumination to flood the subject with IR illumination and image sensor may capture images of the flood IR illuminated subject. Flood IR illumination images may be, for example, two-dimensional images of the subject illuminated by IR light.

In particular, for depth or material detection, projector 106 may provide IR illumination with a pattern. The pattern may be a pattern of light with a known, and controllable, configuration and pattern projected onto a subject. The pattern may be regularly arranged or irregularly arranged in a structured pattern of light pattern. In certain embodiments, the pattern is a speckle pattern. The pattern may include, but not be limited to, dots, speckles, stripes, dashes, nodes, edges, and combinations thereof.

Image sensors of camera 102 and projectors 104, 106 may be included in a single or separate chip package. In some embodiments, image sensors and projectors 104, 106 are located on separate chip packages. Additionally or alternatively to the first and second projectors 104, 106, the image recording device 100 may include further projectors for visible light, e.g., a flash illuminator, projectors for RGB light, and/or projectors for infrared light.

Images captured by recording device 100 may be processed by an image processing device as described, e.g., with reference to FIG. 2.

FIG. 2 schematically and exemplarily shows an image processing device 200 utilizable for generating at least two images of an object. Image processing device 200 may be configured to receive images captured by a camera 202 (not part of the image processing device 200). The camera 202 can be part of the recording device 100 as described with reference to FIG. 1. Accordingly, camera 202 may provide a flood light image showing an object illuminated by flood light and/or may provide a pattern image showing an object illuminated by light patterns.

Image processing device 200 comprises an image processor 204 that may include circuitry suitable for processing images received from camera 202. The image processor 204 may include hardware and/or software, e.g., program instructions, e.g. implementing a trained neural network 205, capable of processing or analyzing images captured by camera 202.

Image processing device 200 further comprises a secure processor 206. Secure processor 206 is provided for sensitive operations, e.g., that are part of an authentication process. Secure processor 206 may be a secure circuit configured to authenticate an active user. Secure processor 206 may be a circuit that protects an isolated, internal resource from being directly accessed by an external circuit. The internal resource may be memory that stores sensitive data such as biometric information, encryptions keys, or the like.

Secure processor 206 may run a facial recognition authentication process based on images captured by camera 202 and processed by image processor 204. A single processor may perform the functions of image processor 204 and secure processor 206.

Image processing device 200 may perform an enrollment process. During the enrollment process, camera 202 may capture or collect images and/or image data from an authorized user to subsequently authenticate the user using the facial recognition authentication process. From images of the enrollment process, templates may be generated and stored in secure processor 206.

On facial authentication, camera 202 may communicate image data to secure processor 206 via a secure channel. The secure channel may be, for example, either a dedicated path for communicating data (i.e., a path shared by only the intended participants) or a dedicated path for communicating encrypted data using cryptographic keys known only to the intended participants. Secure processor 206 may operate one or more machine learning models. One or more neural network modules 207 may be used to operate the machine learning models. Neural network modules may be located in secure processor 206. Secure processor 206 may compare the image characteristics with stored templates for each type of image to generate an authentication score depending on a matching score or other ranking of matching between the user in the captured image and in the stored templates. The authentication scores for the images such as the flood IR and patterned illumination images may be combined to decide on the identity of the user and, if authenticated, allow the user to use device e.g., unlock the device.

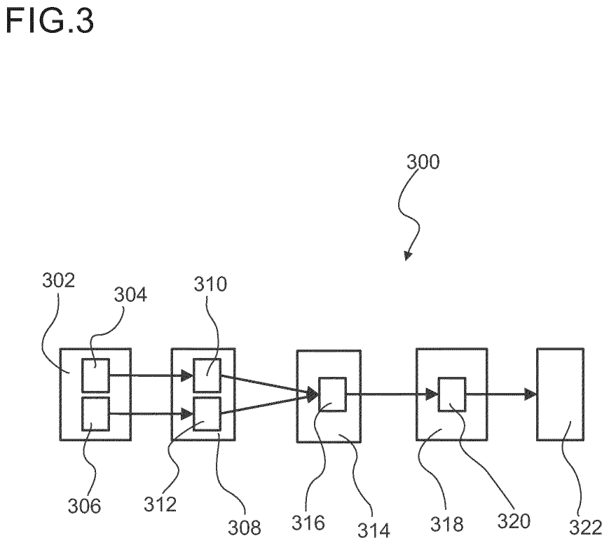

FIG. 3 schematically and exemplarily shows a system 300 for determining a material of an object (not part of the system 300). The system may be part of image processing device 200 as described with reference to FIG. 2. For example, elements of the system may be implemented as part of image processor 204 and/or secure processor 206.

System 300 comprises an image providing unit 302 that is configured for providing at least two images 304, 306 each showing a part of the object. The image providing unit 302 may receive the at least two images 304, 306 from an image recording device, e.g., as described with reference to FIG. 1.

In general, the at least two images 304, 306 are partial images of a region of interest, i.e., each showing a part of the region of interest. The at least two images 304, 306 showing parts of the object may be generated in different ways.

For example, with a camera a region-of-interest image may be captured showing a selected or predefined region of interest of the object. The image can be a flood light image or a pattern image. The image can be divided into the at least two images each showing a part of the region-of-interest image. The at least two images at least two images can be transmitted to the image providing unit 302 of a system 300 for determining a material of an object.

It is also possible that with camera, an image is captured showing the object and some environment that is not of interest. Such an image is an original image that may be pre-processed, preferably, cropped, to generate a region-of-interest image only or substantially showing the selected region of interest. Cropping may be based on identifying peaks of pattern and cropping a certain size around the peaks. In such an embodiment, the peak may be at the center of the image. The partial images may have a fixed size and may not overlap. In another embodiment, the cropping may be random in terms of position of the peaks. The partial images may have any size. The partial images may overlap. The partial images may comprise at least one pattern feature, e.g., an intensity peak, or more pattern features. The partial images may comprise parts of pattern features or outlier signatures of pattern features. Other options are Single shot detection (SSD; region based neural network or mask recurrent neural networks) to provide bounding boxes for partial image cutout. Manipulation may hence be based on cutout via anchor points based on pattern features of pattern image. The region-of-interest image generated by cropping the original image may be divided into the at least two images 304, 306 showing parts of the object and transmitted to an image providing unit 302 of a system 300.

It is also possible that with camera, the at least two images 304, 306 are directly captured, e.g. by scanning the region of interest of the object. In this case, each of the least two images only show a smaller part of a selected region of interest of an object of which the material shall be determined. In his case, the at least two images thus constitute partial images of the region of interest. The at least two images can be directly captured by camera and transmitted to the image providing unit 302 of a system 300 for determining a material of an object.

System 300 comprises a material score determination unit 308 that is configured for determining a material score 310, 312 for each of the at least two images 304, 306. The material score represents a likelihood that the part of the object shown in the respective image 304, 306 comprises the material of interest. A material score cam be expressed by a single value in the range of 0 to 1. Thereby, 0 may indicate a likelihood of 0% that the object shows the material in the respective part and 1 may indicate a likelihood of 100% that the object shows the material in the respective part.

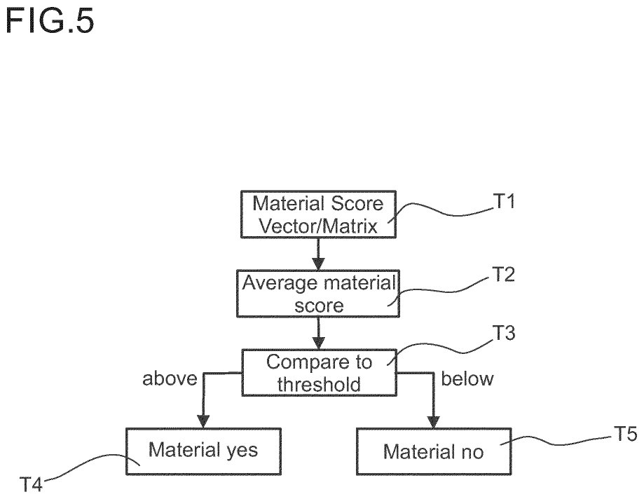

The determined material scores 310, 312 may be passed to an evaluation unit 314 that is configured for evaluating the material scores 310, 312 determined for each of the at least two images 304, 306. The evaluation unit 314 may provide an evaluation result 316 indicative of the evaluation of the material scores 310, 312. For example, the evaluation result 316 may be obtained by forming an average or a sum of the material scores 310, 312. Alternatively, evaluation unit 314 may comprise a trained neural network configured for providing the evaluation result 316 based on the material scores 310, 312. In general, the process of evaluating the material scores 310, 312 can be carried out in various ways some of which are described with reference to FIGS. 5, 6, 7 and 8.

Based on the evaluation result 316, a material determination unit 318 of the system 300 can determine the material 320 of the object. For example, for determining the material 320, the material determination unit 318 may compare the evaluation result 316, e.g., an average of the material scores 310, 312, to a threshold value in order to determine the material 320 of the object. The determined material 320 may then be output by the system's output unit 322.

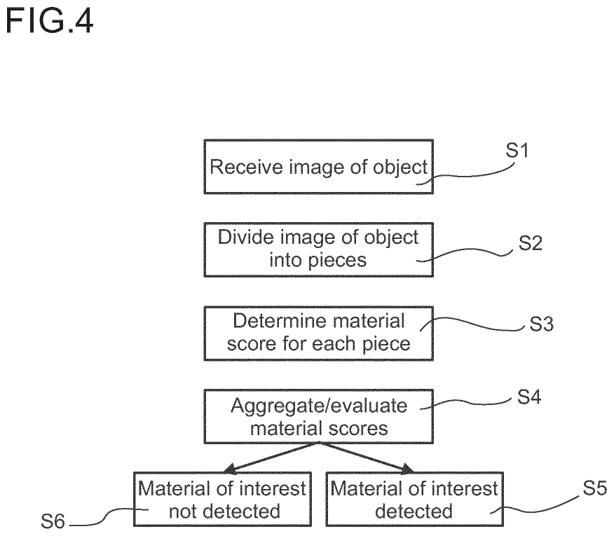

FIG. 4 shows a flowchart representing a method for determining a material of an object. The method can at least partly be conducted using the system 300 as described with reference to FIG. 3.

Initially, an image of the object is received (step S1) that shows a region of interest of the object, e.g., a face. The region-of interest image is divided into a number of partial images such that each partial image represents a different part of the region-of-interest image (step S2). The partial images represent the at least two images that are provided with the image providing unit of a system for determining a material of an object, e.g., as described with reference to FIG. 3.

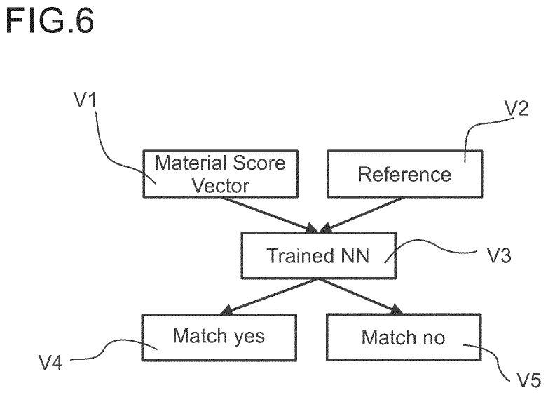

For each partial image, an individual material score is determined (step S3). The material score of a partial image is indicative of a presence of a predefined material in that respective image. The material score of a partial image may be a value between 0 and 1 if only one material is to be detected, e.g. if the part of the face shown in the partial image is made of human skin or not. The material score of a partial image may also be a vector or a matrix if several materials are to be determined in that partial image, e.g., for a floor with a carpet if it is PET, PVC, or wood. When this is done for all partial images, a material score is obtained for each image. The result may be provided by a material score vector or matrix. Subsequently, the material score vector or matrix is aggregated and/or evaluated (step S4) in a way which fits best to a particular use case. Some ways of evaluating the material scores are described with reference to FIGS. 5, 6,7, and 8 and may be included into the method for determining a material of an object as described with reference to FIG. 4.

Based on the evaluation of the material score, the material of the object is determined. The determined material is than matched against the material of interest, e.g., the predefined material to determine whether the determined material is actually the material of interest (step S5) or whether the determined material is different from the material of interest (step S6).

The method described with reference to FIG. 4 may be executed by a computer program including instructions for executing the steps of the method, when run on a computer. The computer program may be stored on a non-transitory computer readable data medium that may be part of system 300 as described with reference to FIG. 3 and/or part of the image processing device as described with reference to FIG. 2.

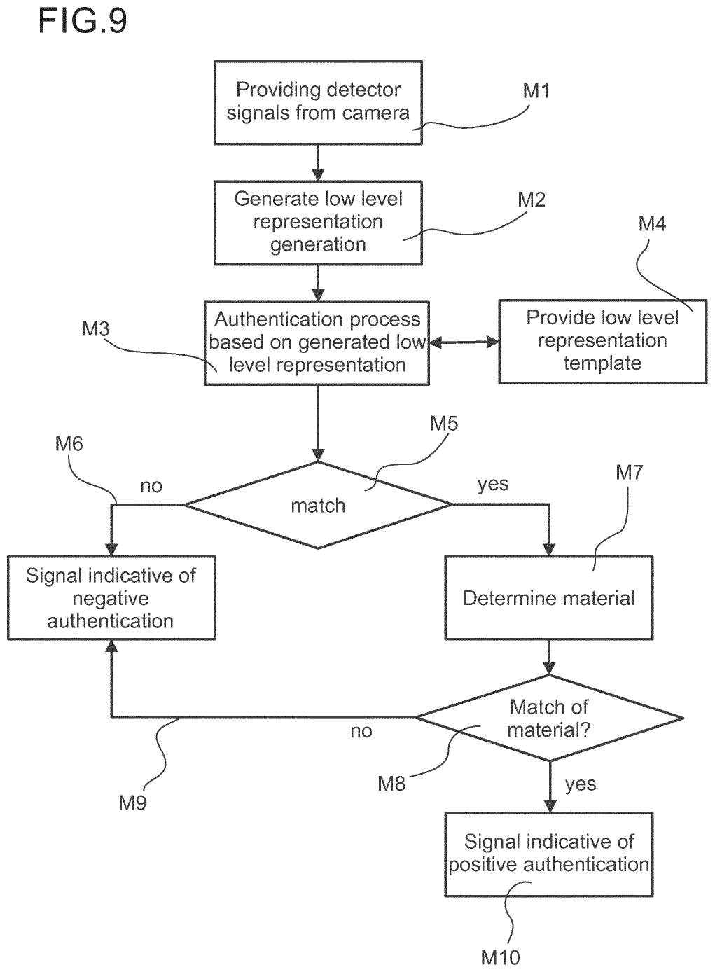

The material of the object determined by conducting the steps of the method as described with reference to FIG. 4 may be used for authentication of the object, e.g., in an authentication process as described with reference to FIG. 9.

With reference to the following FIGS. 5 to 8, different methods of evaluating material scores determined for the at least two images, e.g., partial images of a region-of-interest image, are described. Each of the methods may be included into a method for determining a material of an object as described with reference to FIG. 4.

FIG. 5 shows a flowchart representing steps performed for evaluating material scores by forming an average material score. In particular, in the method an average value of each element in a material score vector or matrix is formed.

To this end, the determined material scores, e.g., expressed as a vector or matrix, are provided (step T1). Based on the determined material scores, an average material score is formed (step T2). The thus obtained average material score is compared to a pre-set threshold value (step T3). If the average material score is above the threshold, the object is identified as being of the material of interest (step T4). Otherwise, it is provided that the object is not of the material of interest (step T5). The determination of the threshold may be important for the reliability of the recognition: If it is too high, it may produce too many false negative results. If it is too low, it may produce too many false positive results. In many cases, the training, evaluation and test data sets are not complete to prepare a system for every conceivable situation it may have to handle. However, the inventors found that good results may be obtained if the threshold is chosen such that the false positive rate and the false negative rate on the test data set is about the same.

FIG. 6 shows a flowchart representing steps performed for evaluating material scores including a comparison of the material scores to a reference.

Initially, a material score, e.g., expressed as a vector or matrix, of an image is provided (step V1). The image may be a partial image of a region-of-interest image. In addition, a reference is provided (step V2). This reference, preferably, is a stored material score vector from an image in which the material of the region of interest is known. In the example of a face authentication, the reference may be a reference image that is available from the enrollment process, in which a new human scans his/her face in order to set up the recognition system.

In the method, the material score of the image is compared to the reference (step V3). In this particular example, the comparison is performed by a trained neural network configured for receiving the material score vector and the reference as input. The neural network may be trained for outputting the binary information if the object is of the material of interest (step V4) or no (step V5). Alternatively, the neural network may be trained for outputting a likelihood, which is translated into the decision by setting a threshold depending on the use case. However, the step of comparing the material score vector and the reference may be realized in a different way such as by implementing a simple element-wise difference formation.

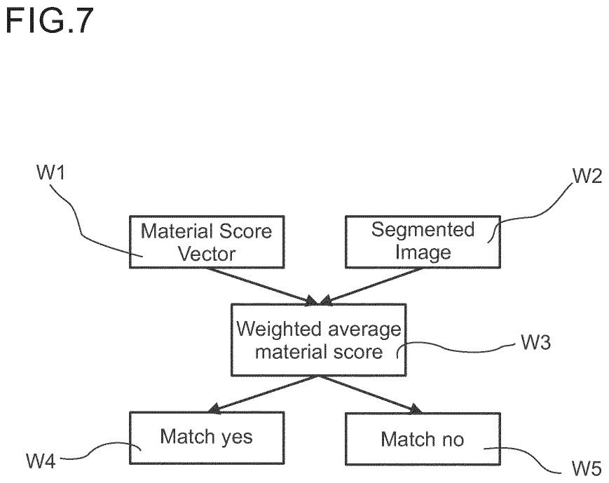

FIG. 7 shows a flowchart representing steps performed for evaluating material scores by forming a weight average material score.

Initially, a material score vector containing the material scores of the parts of the object as elements is provided (step W1). In the method, a segmented image is provided, which comprises segments of the object with an associated weight value indicating how important a respective segment is for the determination of the material (step W2). In the face recognition example, typically the area close to the hair is less important because often hidden by the hair, while the area around the nose and mouth is more important.

Each element of the material score vector may be multiplied with the corresponding weight value in the segmented image. This is possible since each material score is associated with a certain part of the object and can thus be matched to the segmented image showing the object.

Of the weighted material scores a weight average material score is formed (step W3). The weight average material score may be compared to a pre-set threshold value as described for the evaluation process of FIG. 5. If the weight average material score is above the threshold, the object is identified as being of the material of interest (step W4). Otherwise, it is provided that the object is not of the material of interest (step W5).

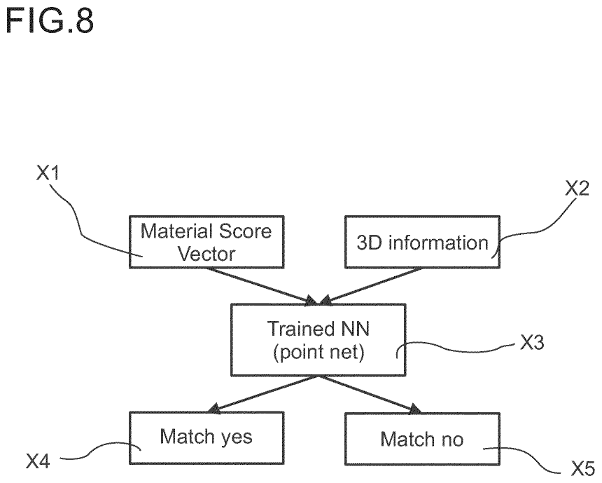

FIG. 8 shows a flowchart representing steps performed for evaluating material scores based on position information provided for each of the material scores.

In the method, a material score vector (step X1) as well as 3D information (step X2) are provided. The 3D information represents the position in space, e.g., in the coordinate system of the object, for each image with an associated material score.

Both, the material score vector and the 3D information are provided as input to a trained neural network (step X3). Preferably, the neural network is a point net neural network. The neural network has learned in a training process at which position the material score is more relevant for the overall estimation than in other positions. The trained neural network will output the decision if the material of the object as determined for a respective image based on the associated material score matches the material of interest (step X4) or not (step X5).

FIG. 9 shows a flowchart representing an authentication process comprising determining a material of an object to be authenticated.

In the method, detector signals representing a feature of the object to be authenticated are provided from a camera (step M1), e.g., representing a face or a fingerprint of a user to be authenticated. For example, for authentication, flood light image may be analyzed for facial features.

Of the detected features of the user to be authenticated, a low-level representation is generated (step M2). Options to build low-level representations of, e.g. a partial image, are fast Fourier transform (FFT), wavelets, deep learning, like a convolutional neural network, energy models, normalizing flows, vision transformers, or autoregressive image modelling.

The authentication is performed based on the generated low-level representation (step M3). To this end, a low-level representation template is provided (step M4). For example, analyzed facial features may be compared to the template. The template may be provided to get a matching score. In certain embodiments, a template space may include a template for an enrollment profile for an authorized user on device, e.g., a template generated during an enrollment process. Matching score may be a score of the differences between facial features and corresponding features in template space, e.g., feature vectors for the authorized user generated during the enrollment process. Matching score may be higher when feature vectors are closer to, e.g., the less distance or less difference, the feature vectors in template space.

Comparing feature vectors and templates from a template space to get a corresponding matching score may include using one or more classifiers or a classification-enabled network to classify and evaluate the differences between the generated feature vectors and feature vectors from the template space. Examples of different classifiers that may be used include, but are not limited to, linear, piecewise linear, nonlinear classifiers, support vector machines, and neural network classifiers. In some embodiments, matching score may be assessed using distance scores between feature vectors and templates from the template space.

For authentication, a matching score may be compared to unlock threshold for device (step M5). Unlock threshold may represent a minimum difference in feature vectors, e.g., between the face of the authorized user according to templates and the face of the user in the unlock attempt to unlock the device. For example, unlock threshold may be a threshold value that determines whether the unlock feature vectors are close enough to the template vectors associated with the authorized user's face.

If matching score is below unlock threshold, the user's face in the captured image for unlocking does not match the face of the authorized user. In this case, a signal indicative of negative authentication is provided (step M6).

Yet, if matching score is above unlock threshold, the users face in the captured image for unlocking matches the face of the authorized user. In this case, a second authentication process may be initiated.

This second authentication process comprises a determination of the material of the part of the user that is presented to the camera (step M7). For determining the material of the user, the method as described with reference to FIG. 4 may be used. For example, the method described with reference to FIG. 4 may be carried out using the system as described with reference to FIG. 3.

When the material is determined, it is checked whether the determined material matches a predefined material of interest (step M8). For example, when combined with a facial recognition process, it may be determined whether the material presented to the camera is indeed human skin and or not, e.g., silicone of a spoofing attach imitating the face of the authorized user.

If the result of the matching is that the determined material does not correspond to the material of interest, a signal indicative of a negative authentication may be provided (step M9).

However, if the user also passes the second authentication step, i.e., the determined material matches the predefined material of interest, a signal indicative of positive authentication may be provided (step M10).

As a result, the user is authenticated as the authorized user for the enrollment profile on the device and the device is unlocked. Unlocking may allowing the user to access to use the device and/or allowing the user to have access to a selected functionality of the device, e.g., unlocking a function of an application running on the device, payment systems or making a payment, access to personal data, expanded view of notifications, etc.

Alternatively, the authentication process may be carried out in way that initially the material of the object presented is determined and only if the material matches the predefined material of interest, afterwards, another second authentication process is carried out such as biometric authentication including, e.g., facial recognition or fingerprint sensing.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like providing at least two images each showing a part of the object, determining a material score for each of the at least two images, evaluating the material scores determined for each of the at least two images, determining the material of the object based on the evaluation, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a classical computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that at least parts of the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, main-frame computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that at least parts of the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

1. A system for determining a material of an object, said system comprising
an image providing unit configured for providing at least two images each showing a part of the object,
a material score determination unit configured for determining a material score for each of the at least two images, said material score being indicative of a presence of a predefined material in the respective image,
an evaluation unit configured for evaluating the material scores determined for each of the at least two images,
a material determination unit configured for determining the material of the object based on the evaluation, and
an output unit configured for outputting the determined material of the object.

2. The system of claim 1, wherein the at least two images are partial images, each showing a part of a region of interest contained in a region-of-interest-image showing a region of interest of the object.

3. The system of claim 1, wherein the material score determination unit comprises a data-driven model configured for determining the material score for each of the at least two images or the material score determination unit comprises a mechanistic model configured for determining the material score for each of the at least two images.

4. The system of claim 1, wherein the evaluation unit is further configured for evaluating the material scores determined for each of the at least two images by forming an average material score of the determined material scores.

5. The system of claim 4, wherein the evaluation unit is further configured for evaluating the material scores determined for each of the at least two images by giving a weight to each of the material scores and by forming a weight average material score of the determined material scores based on the weights assigned to each of the material scores.

6. The system of claim 4, wherein the material determination unit is further configured for determining the material of the object based on the comparison of the average material score or the weight average material score with the predefined threshold value.

7. The system of claim 1, wherein the evaluation unit is further configured for comparing the material scores determined for the at least two images to a reference, said reference comprising at least one reference material score determined from a reference image showing a known reference material.

8. The system of claim 7, wherein the evaluation unit is configured for evaluating the material scores by comparing each of the material scores determined for the at least two images in an element-wise manner to the reference.

9. The system of claim 7, wherein for evaluating the material scores, the evaluation unit comprises a neural network that is trained for receiving the material scores of the at least two images and the reference as input and for outputting based on the input a prediction of the material of the object.

10. The system of claim 7, wherein the material determination unit is configured for determining the material of the object based on the element-wise difference formation of the material scores and the reference or wherein the material determination unit is configured for determining the material of the object by comparing the prediction of the material of the object provided by the trained neural network to a predefined use case threshold value.

11. The system of claim 1, wherein each of the at least two images is provided together with a position information indicative of a relative position on the object and wherein the evaluation unit comprises a neural network that is trained for receiving the material score of a respective image together with the position information of this image as input and for outputting based on the input a prediction of the material of the object.

12. The system of claim 1, further comprising an authentication unit configured for authenticating the object using the determined material of the object.

13. A method for determining a material of an object, said method comprising the steps of
providing at least two images each showing a part of the object,
determining a material score for each of the at least two images, said material score being indicative of a presence of a predefined material in the respective image,
evaluating the material scores determined for each of the at least two images,
determining the material of the object based on the evaluation, and
outputting the determined material of the object.

14. A computer program for determining a material of an object, the computer program including instructions for executing the steps of the method of claim 13, when run on a computer.

15. A non-transitory computer readable data medium storing the computer program of claim 14.

16. The system of claim 3, wherein the data-driven model is a neural network trained for determining the material score for each of the at least two images using the at least two images as input.
